(19) United States
(12) Patent Application Publication
(10) Pub. No.: US 2009/0067848 A1
(43) Pub. Date: Mar. 12, 2009

(54) LIMITED LIFE TRANSCEIVER

(75) Inventors: Luke M. Ekkizogloy, San Jose, CA (US); Gerald L. Dybsetter, Scotts Valley, CA (US)

Correspondence Address: Workman Nydegger;1000 Eagle Gate Tower, 60 East South Temple, Salt Lake City, UT, 84111, US

(73) Assignee: FINISAR CORPORATION, SUNNYVALE, CA (US)

(21) Appl. No.: 11/851,983

(22) Filed: Sep. 7, 2007

(51) Int. Cl. H04B 10/00

(52) U.S. Cl. 398/135

(57) ABSTRACT

Systems and methods for an optical transceiver module to limit the amount of time the optical transceiver module is allowed to operate. The optical transceiver module includes at least one processor, a persistent memory and a system memory. The persistent memory, which is coupled to the at least one processor, contains microcode. The microcode is loaded from the persistent memory to the system memory and executed by the at least one processor. The executed microcode causes the optical transceiver module to detect the amount of time that the optical transceiver has been operating. The optical transceiver module then determines if the detected amount of operating time is in excess of a predetermined amount of operating time. If the detected operating time is in excess of the predetermined amount of operating time, the optical transceiver module causes itself to become non-operational. The optical transceiver module may then report its operational status.

### CROSS-REFERENCE TO RELATED APPLICATIONS

Not applicable.

### BACKGROUND

Computing and networking technology have transformed our world. As the amount of information communicated over networks has increased, high speed transmission has become ever more critical. Many high speed data transmission networks rely on optical transceivers and similar devices for facilitating transmission and reception of digital data embodied in the form of optical signals over optical fibers. Optical networks are thus found in a wide variety of high speed applications ranging from modest Local Area Networks (“LANs”) to backbones that define a large portion of the infrastructure of the Internet.

Typically, data transmission in such networks is implemented by way of an optical transmitter (also referred to as an “optoelectronic transducer”), such as a laser or Light Emitting Diode (“LED”). The optoelectronic transducer emits light when current is passed through it, the intensity of the emitted light being a function of the magnitude of the current. Data reception is generally implemented by way of an optical receiver (also referred to as an optoelectronic transducer), an example of which is a photodiode. The optoelectronic transducer receives light and generates a current, the magnitude of the generated current being a function of the intensity of the received light.

Various other components are also employed by the optical transceiver to aid in the control of the optical transmit and receive components, as well as the processing of various data and other signals. For example, such optical transceivers typically include a driver (e.g. referred to as a “laser driver” when used to drive a laser signal) configured to control the operation of the optical transmitter in response to various control inputs. The optical transceiver also generally includes an amplifier (e.g., often referred to as a “post-amplifier”) configured to amplify the channel-attenuated received signal prior to further processing. A controller circuit (hereinafter referred to as the “controller”) controls the operation of the laser driver and post-amplifier.

Controllers are typically implemented in hardware as state machines. Their operation is fast, but inflexible. Being primarily state machines, the functionality of the controller is limited to the hardware structure of the controller. What would be advantageous are controllers that have more flexible functionality.

### BRIEF SUMMARY

The embodiments disclosed herein relate to systems and methods for an optical transceiver module to limit the amount of time the optical transceiver module is allowed to be operational. The optical transceiver module includes at least one processor, a persistent memory and a system memory.

The persistent memory, which is coupled to the at least one processor, contains microcode. The microcode is loaded from the persistent memory to the system memory and executed by the at least one processor. The executed microcode causes the optical transceiver module to detect the amount of time that the optical transceiver has been operating. The optical transceiver module then determines if the detected amount of operating time is in excess of a predetermined amount of operating time. If the detected operating time is in excess of the predetermined amount of operating time, the optical transceiver module causes itself to become non-operational. The optical transceiver module may then report its operational status.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the embodiments disclosed herein. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 schematically illustrates an exemplary optical transceiver that may implement features of the present invention;

FIG. 2 schematically illustrates an example of a control module used in the transceiver of FIG. 1;

FIG. 3 illustrates an exemplary software architecture that may be maintained in system memory in accordance with the principles of the present invention; and

FIG. 4 illustrates a method for limiting the life of an optical transceiver module in accordance with one embodiment of the present invention.

### DETAILED DESCRIPTION

The embodiments disclosed herein relate to systems and methods for an optical transceiver module to limit the amount of time the optical transceiver module is allowed to be operational. The optical transceiver module includes at least one processor, a persistent memory and a system memory.

The persistent memory, which is coupled to the at least one processor, contains microcode. The microcode is loaded from the persistent memory to the system memory and executed by the at least one processor. The executed microcode causes the optical transceiver module to detect the amount of time that the optical transceiver has been operating. The optical transceiver module then determines if the detected amount of operating time is in excess of a predetermined amount of operating time. If the detected operating time is in excess of the predetermined amount of operating time, the optical transceiver module causes itself to become non-operational. The optical transceiver module may then report its operational status.

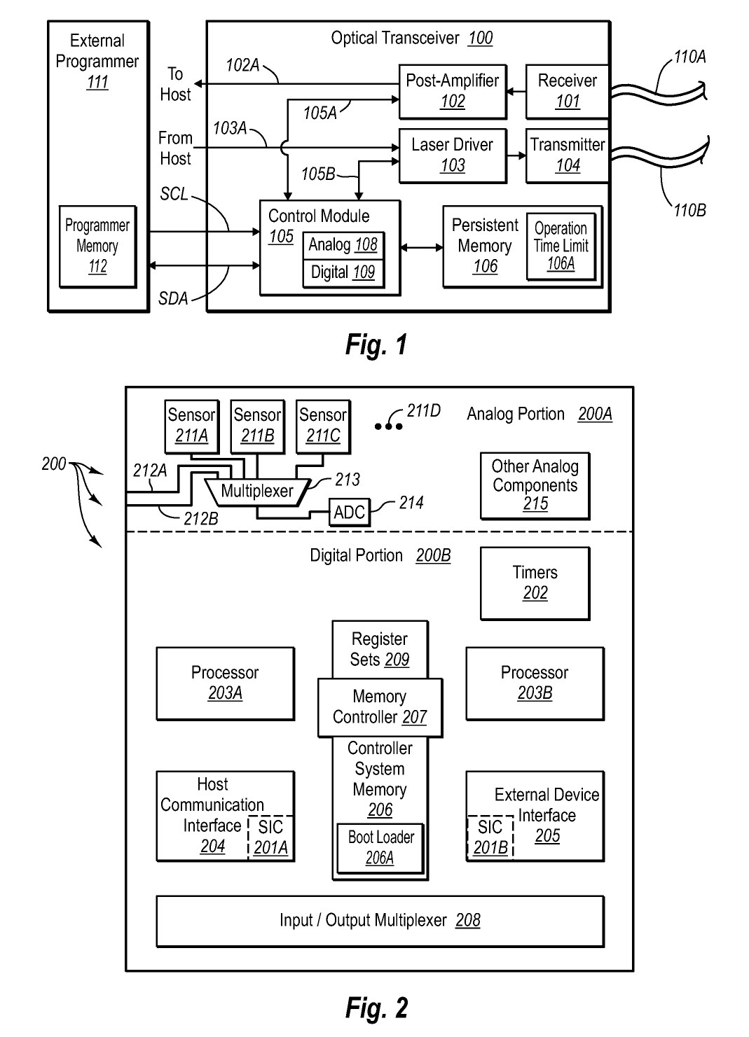

FIG. 1 illustrates an optical transceiver 100 in which the principles of the present invention may be employed. While the optical transceiver 100 will be described in some detail, the optical transceiver 100 is described by way of illustration only, and not by way of restricting the scope of the invention. The principles of the present invention are suitable for 1G, 2G, 4G, 8G, 10G and higher bandwidth fiber optic links. Furthermore, the principles of the present invention may be implemented in optical (e.g., laser) transmitter/receivers of any form factor such as XFP, SFP and SFF, without restriction. Having said this, the principles of the present invention are not limited to an optical transceiver environment at all.

The optical transceiver 100 receives an optical signal from fiber 110A using receiver 101. The receiver 101 acts as an opto-electric transducer by transforming the optical signal into an electrical signal. The receiver 101 provides the resulting electrical signal to a post-amplifier 102. The post-amplifier 102 amplifies the signal and provides the amplified signal to an external host 111 as represented by arrow 102A. The external host 111 may be any computing system capable of communicating with and/or providing microcode to the optical transceiver 100. The external host 111 may contain a host memory 112 that may be a volatile or non-volatile memory source. In one embodiment, the optical transceiver 100 may be a printed circuit board or other components/chips within the host 111, although this is not required.

The optical transceiver 100 may also receive electrical signals from the host 111 for transmission onto the fiber 110B. Specifically, the laser driver 103 receives the electrical signal as represented by the arrow 103A, and drives the transmitter 104 (e.g., a laser or Light Emitting Diode (LED)) with signals that cause the transmitter 104 to emit onto the fiber 110B optical signals representative of the information in the electrical signal provided by the host 111. Accordingly, the transmitter 104 serves as an electro-optic transducer.

The behavior of the receiver 101, the post-amplifier 102, the laser driver 103, and the transmitter 104 may vary dynamically due to a number of factors. For example, temperature changes, power fluctuations, and feedback conditions may each affect the performance of these components. Accordingly, the optical transceiver 100 includes a control module 105, which may evaluate temperature and voltage conditions and other operational circumstances, and receive information from the post-amplifier 102 (as represented by arrow 105A) and from the laser driver 103 (as represented by arrow 105B). This allows the control module 105 to optimize the dynamically varying performance, and additionally detect when there is a loss of signal.

Specifically, the control module 105 may counteract these changes by adjusting settings on the post-amplifier 102 and/or the laser driver 103 as also represented by the arrows 105A and 105B. These settings adjustments are quite intermittent since they are only made when temperature or voltage or other low frequency changes so warrant. Receive power is an example of such a low frequency change.

The control module 105 may have access to a persistent memory 106, which in one embodiment, is an Electrically Erasable and Programmable Read Only Memory (EEPROM). The persistent memory 106 and the control module 105 may be packaged together in the same package or in different packages without restriction. Persistent memory 106 may also be any other non-volatile memory source.

The control module 105 includes both an analog portion 108 and a digital portion 109. Together, they allow the control module to implement logic digitally, while still largely interfacing with the rest of the optical transceiver 100 using analog signals. FIG. 2 schematically illustrates an example 200 of the control module 105 in further detail. The control module 200 includes an analog portion 200A that represents an example of the analog portion 108 of FIG. 1, and a digital portion 200B that represents an example of the digital portion 109 of FIG. 1.

For example, the analog portion 200A may contain digital to analog converters, analog to digital converters, high speed comparators (e.g., for event detection), voltage based reset generators, voltage regulators, voltage references, clock generator, and other analog components. For example, the analog portion 200A includes sensors 211A, 211B, 211C amongst potentially others as represented by the horizontal ellipses 211D. Each of these sensors may be responsible for measuring operational parameters that may be measured from the control module 200 such as, for example, supply voltage and transceiver temperature. The control module may also receive external analog or digital signals from other components within the optical transceiver that indicate other measured parameters such as, for example, laser bias current, transmit power, receive power, laser wavelength, laser temperature, and Thermo Electric Cooler (TEC) current. Two external lines 212A and 212B are illustrated for receiving such external analog signals although there may be many of such lines.

The internal sensors may generate analog signals that represent the measured values. In addition, the externally provided signals may also be analog signals. In this case, the analog signals are converted to digital signals so as to be available to the digital portion 200B of the control module 200 for further processing. Of course, each analog parameter value may have its own Analog to Digital Converter (ADC). However, to preserve chip space, each signal may be periodically sampled in a round robin fashion using a single ADC such as the illustrated ADC 214. In this case, each analog value may be provided to a multiplexer 213, which selects in a round robin fashion, one of the analog signals at a time for sampling by the ADC 214. Alternatively, multiplexer 213 may be programmed to allow any order of analog signals to be sampled by ADC 214.

As previously mentioned, the analog portion 200A of the control module 200 may also include other analog components 215 such as, for example, digital to analog converters, other analog to digital converters, high speed comparators (e.g., for event detection), voltage based reset generators, voltage regulators, voltage references, clock generator, and other analog components. The digital portion 200B of the control module 200 may include a timer module 202 that provides various timing signals used by the digital portion 200B. Such timing signals may include, for example, programmable processor clock signals. The timer module 202 may also act as a watchdog timer.

Two general-purpose processors 203A and 203B are also included. The processors recognize instructions that follow a particular instruction set, and may perform normal general-purpose operation such as shifting, branching, adding, subtracting, multiplying, dividing, Boolean operations, comparison operations, and the like. In one embodiment, the general-purpose processors 203A and 203B are each a 16-bit processor and may be identically structured. The precise structure of the instruction set is not important to the principles of the present invention as the instruction set may be optimized around a particular hardware environment, and as the precise hardware environment is not important to the principles of the present invention.

A host communications interface 204 is used to communicate with the host 111 possibly implemented using a two-wire interface such as I²C shown in FIG. 1 as the serial data (SDA) and serial clock (SCL) lines on the optical transceiver 100. Other host communication interfaces may also be implemented as well. Data may be provided from the control module 105 to the host 111 using this host communications interface to allow for digital diagnostics and readings of temperature levels, transmit/receiver power levels, and the like. The external device interface 205 is used to communicate with, for example, other modules within the optical transceiver 100 such as, for example, the post-amplifier 102, the laser driver 103, or the persistent memory 106.

The internal controller system memory 206 (not to be confused with the external persistent memory 106) may be Random Access Memory (RAM) or non-volatile memory. The memory controller 207 shares access to the controller system memory 206 amongst each of the processors 203A and 203B and with the host communication interface 204 and the external device interface 205. In one embodiment, the host communication interface 204 includes a serial interface controller 201A, and the external device interface 205 includes a serial interface controller 201B. The two serial interface controllers 201A and 201B may communicate using a two-wire interface such as I²C or may be another interface so long as the interface is recognized by both communicating modules. One serial interface controller (e.g., serial interface controller 201B) is a master component, while the other serial interface controller (e.g., serial interface controller 201A) is a slave component.

An input/output multiplexer 208 multiplexes the various input/output pins of the control module 200 to the various components within the control module 200. This enables different components to dynamically assign pins in accordance with the then-existing operational circumstances of the control module 200. Accordingly, there may be more input\output nodes within the control module 200 than there are pins available on the control module 200, thereby reducing the footprint of the control module 200.

Register sets 209 contain a number of individual registers. These registers may be used by the processors 203 to write microcode generated data that controls high speed comparison in optical transceiver 100. Alternatively, the registers may hold data selecting operational parameters for comparison. Additionally, the registers may be memory mapped to the various components of optical transceiver 100 for controlling aspects of the component such as laser bias current or transmit power.

Having described a specific environment with respect to FIGS. 1 and 2, it will be understood that this specific environment is only one of countless architectures in which the principles of the present invention may be employed. As previously stated, the principles of the present invention are not intended to be limited to any particular environment. Accordingly, the principles of the present invention relate to systems and methods that verify that an optical transceiver has access privileges to microcode received from the host computing system or other sources. The principles of the present invention will be discussed with reference to the environment described in relation to FIGS. 1 and 2.

During manufacture of optical transceiver modules such as optical transceiver 100, it is typical to produce the modules in different manufacturing phases. For example, an Alpha phase of modules is typically the first to be manufactured. The Alpha modules are then supplied to one or more customers for testing and other evaluation for a determined amount of time. The customers may then advise the transceiver manufacturer of any problems that need to be corrected in future manufacturing phases.

The optical transceiver module manufacturer may then produce a Beta phase of modules that have been updated to correct any problems discovered in the Alpha phase as well as any other upgrades added by the manufacturer. Other manufacturing phases may also be performed before a final product manufacturing phase is reached.

Although the use of one or more manufacturing phases such as an Alpha phase has proven to be a successful way to test and improve optical transceiver modules, several problems are created. For example, the optical transceiver 100 module manufacturer often provides one or more Alpha modules to a customer for testing and evaluation as previously described. However, it is often the case that the customer does not return the Alpha modules to the manufacturer at the completion of the Alpha phase for various reasons. For instance, some customers receive large numbers of Alpha modules and it may be difficult to track which modules are Alpha modules. In other cases, the day-to-day demands of the business cycle may make it difficult to track the Alpha modules.

As may be appreciated, not receiving the Alpha modules back may be problematic for the optical transceiver 100 module manufacturer. For example, a customer may continue to use an Alpha module with Beta or later phase modules. The customer may then become upset if the Alpha phase module does not function the same as the Beta or later phase modules, even though the Alpha phase module may not have had the same functionality designed into it. Alternatively, the customer may sell the Alpha module to a different customer. This new customer, not knowing the module is an Alpha module, may expect it to function like a Beta or later phase module and may become upset when it does not function as expected. In either scenario, the reputation of the optical transceiver module manufacturer may suffer due to the improper use of the Alpha modules by the customers.

Advantageously, the principles of the present invention allow for an optical transceiver module manufacturer to limit the amount of time that an optical transceiver module may be operational. Accordingly, the manufacturer is able to ensure that an Alpha module is not used longer than a reasonable period necessary for Alpha module testing. Of course, the principles of the present invention also allow for the manufacturer to limit the amount of operational time for other legitimate business purposes as well.

In accordance with the principles of the present invention, at manufacture time an optical transceiver 100 module manufacturer may desire to include an optical transceiver operating time limit 106A. In some embodiments, the optical transceiver operating time limit 106A may be added to the optical transceiver after manufacture. The optical transceiver operating time limit 106A may be stored in persistent memory 106 or some other accessible memory location. The optical transceiver operating time limit 106A may include a predetermined amount of time that optical transceiver module 100 is to be allowed to operate. For example, in some embodiments the predetermined amount of time may be 1000 hours or perhaps a year. As will be appreciated, virtually any amount of time as may be desired by optical transceiver module 100 manufacturer may be specified as operating time limit 106A. Of course, a shorter period of time may be useful in helping to prevent an Alpha module from being used for a long period of time.

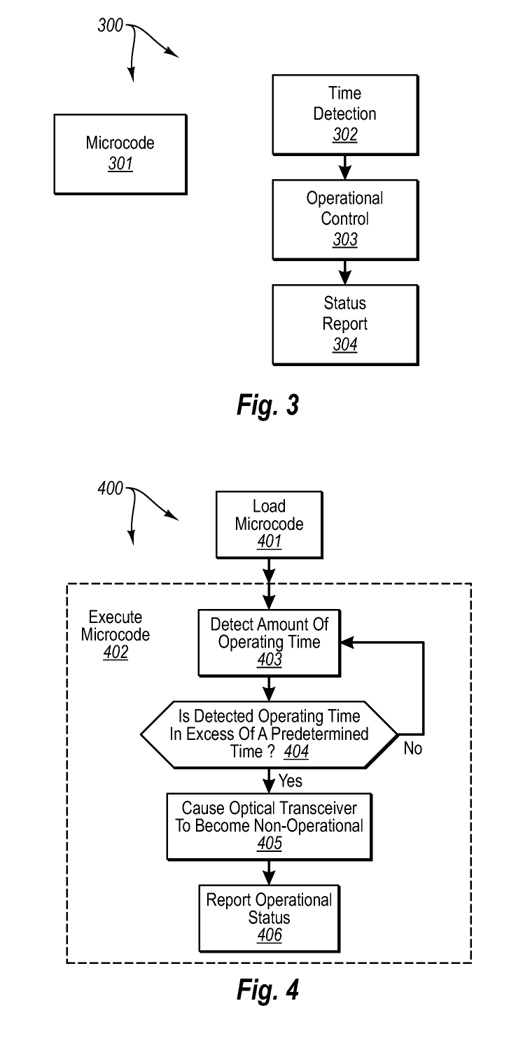

Reference is now made to FIG. 3, which illustrates a software architecture 300 that may be instantiated in system memory 206. In particular, the processors 203 load microcode 301 into the system memory 206 from the persistent memory 106. In the description and in the claims, “microcode” is defined to mean any type of operational or control code, such as, but not limited to, firmware and software, that runs on a microprocessor and controls the operation of the optical transceiver when executed. The remainder of the software architecture 300 is either instantiated in system memory 206 upon the execution of the microcode 301, or else abstractly represents functionality implemented by the optical transceiver 100 upon the execution of the microcode 301. Alternatively, the microcode 301 may be directly executed from persistent memory. In that case, the microcode 301 is loaded into the system memory a fraction at a time (e.g., one instruction at a time) for execution by the processor. In this latter case, the system memory may be a register, flip-flops, or any other memory regardless of size or type.

The software architecture 300 includes a time detection component 302, an operational control component 303, and status report component 304. Of course, it will be appreciated after reading this description that other components or modules may be instantiated in system memory 206 in accordance with the principles of the present invention as circumstances warrant. The software architecture 300 of FIG. 3 will be described with reference to FIG. 4, which illustrates a flowchart of an exemplary method 400 for the optical transceiver to limit the operating life of an optical transceiver module.

First, the optical transceiver 100 loads the microcode 301 from persistent memory 106 to system memory 206 (act 401). One or more of the processors 203 then execute the microcode (act 402). The microcode 301 is structured such that the optical transceiver 100 performs the acts illustrated at act 402 when executed. Specifically, the processors 203 cause the optical transceiver 100 to detect the amount of time that optical transceiver 100 has been operating (act 403), to determine if the detected operating time is in excess of a predetermined operating time (act 404), to cause optical transceiver 100 to become non-operational if the detected operating time is in excess of the predetermined operating time (act 405), and to report its operational status (act 406).

In further detail, at act 401, the microcode for performing one or more diagnostic self-tests is loaded. Exemplarily, one or more of the processors 203 load microcode stored in persistent memory 106 into controller system memory 206. If the persistent memory 106 is an I²C EEPROM, then this may be accomplished using the conventional I²C two-wire interface. However, for other persistent memories, other communication protocols may be used. The microcode from persistent memory 106 includes functions that direct the end of life calculation. At act 402, one or more of the processors 203 execute the microcode loaded during act 401.

In response to the execution of the microcode, at act 403 the optical transceiver 100 detects the amount of time optical transceiver 100 has been operating. For example, an internal clocking mechanism may be configured to track the amount of time that optical transceiver 100 has operated. In some embodiments, the internal clocking mechanism may correspond to timers 202 previously described. In other embodiments, the internal clocking mechanism may correspond to an analog timer that is part of other analog components 215. In still other embodiments, the internal clocking mechanism may be some other component or module of either control module 105 or optical transceiver 100. The time detection component 302 may then make the amount of operating time detected by the internal clocking mechanism available to the other functional components of the architecture 300.

At act 404, the time detection component 302 determines if the detected operating time is in excess of a predetermined operating time. In one embodiment, the determination of act 404 is performed by the time detection component 302 accessing the optical transceiver operating time limit 106A described above and comparing that value with the detected actual operating time. In other embodiments, the determination may be performed by other methods known in the art. Note that in the description and in the claims, the terms “operating” and “operational”, when in used in reference to an optical transceiver, are defined to mean when the optical transceiver is performing its normal functions, which may include, but are not limited to, converting an electrical signal into an optical signal for transmission and converting a received optical signal into an electrical signal. It will be appreciated that other normal functions are also covered by the definition of “operating” and “operational”.

If the detected time is not in excess of the predetermined time (No in decision block 404), then the process returns to act 403 where the operating time is again detected and the determination of act 404 is again made. If, however, the time detection component 302 determines that the detected operating time does exceed the predetermined operating time (Yes in decision block 404), then at act 405 the operational control component 303 may cause operational transceiver 100 to become non-operational.

For example, in some embodiments, operational control component 303 may cause control module 105 to prevent current or other signals from being provided by laser driver 103 to transmitter or laser 104. In this way, the optical transceiver 100 would no longer be able to transmit any signals. In other embodiments, the operational control component 303 may cause control module 105 to disable receiver 101 and/or post-amplifier 102 so that optical transceiver 100 would not longer be able to receive and/or process received optical signals. In still other embodiments, operational control component 303 may cause control module 105 to prevent any signals from being received from or transmitted to host 111, thus also causing optical transceiver 100 to become non-operational. It will be appreciated after reading this description that the principles of the present invention anticipate various other ways exist to make optical transceiver 100 non-operational.

At act 406, the status report component 304 may report the operational status of optical transceiver module 100. For example, in one embodiment, status report component 304 may write to a register 209, a portion of persistent memory 106, or a memory location of host memory 112 (using the I²C bus or other implemented bus) a status indicator that indicates that optical transceiver 100 is an Alpha module and that its operational time has expired. This memory location may be polled by host 111 and the status reported to user of optical transceiver 100.

In some embodiments, status report component 304 may also be configured to write status updates that indicate the amount of time that optical transceiver 100 has been operational. For example, the amount of operational time detected at act 402 may be written by report status component 304 to one of the memory locations discussed previously. When the memory location is polled by host 111, the amount of time remaining until optical transceiver 100 becomes non-operational may be reported to the user.

In some embodiments, a user of optical transceiver 100 may desire that the optical transceiver become operational again after it has been rendered non-operational by the process described above. Alternatively, the user may desire that of optical transceiver 100 remain operational by preventing the process described above. To facilitate these, in some embodiments optical transceiver 100 may be configured to allow a user to update the microcode that causes the transceiver to operate. In this way, an expired Alpha module or an Alpha module that is about to expire may be updated so that the module is functionally equivalent to a newer optical transceiver module. Systems and methods for updating this operational microcode are taught in commonly assigned, co-pending U.S. patent application Ser. No. 11/241,051, filed Sep. 30, 2005 and U.S. patent application Ser. No. 11/320,180, filed Dec. 28, 2005, both of which are herein incorporated by reference in their entirety.

Accordingly, the principles of the present invention allow an optical transceiver module manufacturer to determine how long an optical transceiver module will be allowed to operate. This advantageously prevents the use of Alpha phase modules beyond an amount of time deemed appropriate by the manufacturer, which in turn helps to preserve the business reputation of the manufacture and to ensure that Alpha modules are used only as intended by the manufacturer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In an optical transceiver, a method of controlling the amount of time that the optical transceiver is allowed to operate, the method comprising:
an act of detecting the amount of time that an optical transceiver has been operating;
an act of determining if the detected amount of operating time is in excess of a predetermined amount of operating time; and
an act of causing the optical transceiver to become non-operational if the detected amount of operating time exceeds the predetermined amount of operating time.

2. The method in accordance with claim 1, wherein the method is governed by a processor executing microcode.

3. The method in accordance with claim 1 further comprising:
an act of reporting the operational status of the optical transceiver.

4. The method in accordance with claim 3, wherein the reported operational status informs a host computing system of at least one of the amount of operating time remaining for the optical transceiver or that the operating time of the optical transceiver has expired.

5. The method in accordance with claim 1, wherein the act of determining if the detected amount of operating time is in excess of a predetermined amount of operating time comprises:
an act of accessing a predetermined operating time limit for the optical transceiver;
an act of accessing the detected amount of time that the optical transceiver has been operating; and
an act of comparing the predetermined operating time limit and the detected amount of operating time.

6. The method in accordance with claim 1, wherein act of causing the optical transceiver to become non-operational if the detected amount of operating time exceeds the predetermined amount of operating time comprises one of preventing any signal from being provided to a laser transmitter of the optical transceiver, preventing signals being received by a receiver of the optical transceiver, and preventing any signals being sent to or received from a host computing system.

7. An optical transceiver module comprising the following:
at least one processor;
a system memory;
a persistent memory, wherein the persistent memory contains microcode that when executed by the at least one processor, causes the optical transceiver module to perform the following:
an act of detecting the amount of time that an optical transceiver has been operating;
an act of determining if the detected amount of operating time is in excess of a predetermined amount of operating time; and
an act of causing the optical transceiver to become non-operational if the detected amount of operating time exceeds the predetermined amount of operating time.

8. The optical transceiver module in accordance with claim 7, wherein the executed microcode further causes the optical transceiver module to perform the following:
an act of reporting the operational status of the optical transceiver.

9. The optical transceiver module in accordance with claim 8, wherein the reported operational status informs a host computing system of at least one of the amount of operating time remaining for the optical transceiver or that the operating time of the optical transceiver has expired.

10. The optical transceiver module in accordance with claim 7, wherein the optical transceiver module further comprises an internal clocking mechanism configured to detect the amount of operating time and wherein the persistent memory has stored thereon a predetermined operating time limit for the optical transceiver, the act of determining if the detected amount of operating time is in excess of a predetermined amount of operating time comprising:
an act of accessing the predetermined operating time limit from the persistent memory;
an act of accessing the detected amount of time that the optical transceiver has been operating from the internal clocking mechanism; and
an act of comparing the predetermined operating time limit and the detected amount of operating time.

11. The optical transceiver module in accordance with claim 7, further comprising a laser transmitter and a receiver, the act of causing the optical transceiver to become non-operational if the detected amount of operating time exceeds the predetermined amount of operating time comprising one of preventing any signals being provided to the laser transmitter, preventing signals being received by the receiver, and preventing any signals being sent to or received from a host computing system that is coupled to the optical transceiver module.

12. The optical transceiver module in accordance with claim 7 further comprising:
one or more modules configured to facilitate the receiving of new microcode, the new microcode configured to cause the optical transceiver module to become operational after a period of being non-operational or to cause the optical transceiver to continue to be operational.

13. The optical transceiver module in accordance with claim 7, wherein the optical transceiver module is one of a 1G laser transceiver, a 2G laser transceiver, a 4G laser transceiver, a 8G laser transceiver, a 10G laser transceiver, or a

14. The optical transceiver module in accordance with claim 7, wherein the optical transceiver module is a laser transceiver suitable for fiber optic links greater than 10G.

15. The optical transceiver module in accordance with claim 7, wherein the optical transceiver module is one of a XFP laser transceiver, a SFP laser transceiver, or a SFF laser transceiver.

16. In an optical transceiver module that includes at least one processor, a persistent memory and a system memory, a method for the optical transceiver module to limit the amount of time the optical transceiver module is allowed to be operational, the method comprising the following:
an act of loading microcode from the persistent memory to the system memory;
an act of executing the microcode using the at least one processor, wherein the microcode is structured such that the optical transceiver module performs the following when executed by the at least one processor:
an act of detecting the amount of time that an optical transceiver has been operating;
an act of determining if the detected amount of operating time is in excess of a predetermined amount of operating time; and
an act of causing the optical transceiver to become non-operational if the detected amount of operating time exceeds the predetermined amount of operating time.

17. The method in accordance with claim 16 further comprising:
an act of reporting the operational status of the optical transceiver.

18. The method in accordance with claim 17, wherein the reported operational status informs a host computing system of at least one of the amount of operating time remaining for the optical transceiver or that the operating time of the optical transceiver has expired.

19. The method in accordance with claim 16, wherein the act of determining if the detected amount of operating time is in excess of a predetermined amount of operating time comprises:
an act of accessing from the persistent memory a predetermined operating time limit for the optical transceiver;
an act of accessing the detected amount of time that the optical transceiver has been operating; and
an act of comparing the predetermined operating time limit and the detected amount of operating time.

20. The method in accordance with claim 16, wherein act of causing the optical transceiver to become non-operational if the detected amount of operating time exceeds the predetermined amount of operating time comprises one of preventing any signal from being provided to a laser transmitter of the optical transceiver, preventing signals being received by a receiver of the optical transceiver, and preventing any signals being sent to or received from a host computing system.
